(19) United States
(12) Patent Application Publication
(10) Pub. No.: US 2020/0022414 A1
(43) Pub. Date: Jan. 23, 2020

(54) DEVICE FOR POWERING ELECTRONIC CIGARETTES FROM A MOBILE DEVICE

(71) Applicant: Jokki Labs LLC, Miami Beach, FL (US)

(72) Inventor: Jordan LEEDS, Miami Beach, FL (US)

(21) Appl. No.: 16/514,453

(22) Filed: Jul. 17, 2019

Related U.S. Application Data
(60) Provisional application No. 62/699,068, filed on Jul. 17, 2018.

(51) Int. Cl. A24F 47/00; H02J 7/00; H01R 13/622; H01R 35/04

(52) U.S. Cl. CPC A24F 47/008; H02J 7/0013; H02J 7/345; H01R 35/04; H01R 13/622

(57) ABSTRACT

A device is provided for powering an electronic cigarette from a mobile phone. The device includes a body having a mobile phone dock connector, a conversion circuit housed within the body, and a power providing connector, which in some variations comprises a threaded connector. The mobile phone dock connector may extend from the body and may be configured to connect to a power output interface of a mobile phone. The conversion circuit may be housed within the body of the device and coupled to the mobile phone dock connector, and configured to convert, regulate, or otherwise control the voltage, current, and/or combined power. The power providing connector may extend from the housing or be seated within the housing and electronically coupled to the conversion circuit and is configured to supply power to a heating element within an electronic cigarette. Optionally, the power providing connector may not be electronically coupled to the conversion circuit in an instance in which the conversion circuit is connected directly to a heating element, and the electronic cigarette or vape pen portion that attaches to the power providing coupler is the reservoir of fluid to be atomized or vaporized by the heating element.

### CROSS-REFERENCE TO RELATED APPLICATIONS

This application claims priority to U.S. Provisional Patent Application Ser. No. 62/699,068, filed on Jul. 17, 2018, the contents of which are hereby incorporated by reference in their entirety.

### FIELD OF INVENTION

The present disclosure relates to electronic cigarettes and, more particularly, drawing and converting power from portable devices for powering electronic cigarettes.

### BACKGROUND

Electronic cigarettes, vape pens, e-cigs, and the like have risen in popularity due to their ease and convenience of use, while not suffering the drawbacks of conventional cigarettes and tobacco. Electronic cigarettes require power to heat a heating element that is used to atomize or vaporize a liquid, which is then inhaled by a user. The e-cigarette can take the form of an “Open” or “Closed” system, which indicates how the liquid is delivered to the heating mechanism. In an “Open” system, the liquid is manually provided to the system by way of a cartridge, and often has a removable mouthpiece. In such systems a user can swap out different cartridges of liquid for use in the e-cigarette, and can continue to use the system with a renewed cartridge when one runs out. Conversely, in a “Closed” system, the tank or cartridge containing the liquid is attached to the battery, and often take the form of disposable e-cigarettes that can be discarded after the liquid in the tank runs out. In either system, the heating element requires a battery to provide power and to make the electronic cigarette portable. Rechargeable batteries are widely available and relatively inexpensive allowing the user to carry one or more batteries for an electronic cigarette to increase the usability of the electronic cigarette between charges. However, rechargeable batteries are inherently problematic, as they require the user to actively manage the charging and recharging of each battery, and the individual batteries themselves are susceptible to being lost.

### SUMMARY

Accordingly, an objective of this present disclosure is to provide a device for powering an electronic cigarette.

An embodiment of this present disclosure includes a device for powering an electronic cigarette from a mobile device. The device may include a body, a power receiving connector, a conversion circuit, and a power providing connector. The body defines a first end and a second end. The power receiving connector extends from the first end and is configured to be received within a power output port of a mobile device. The conversion circuit is disposed within the body and electronically coupled between the power receiving connector and the power providing connector and the conversion circuit is configured to convert the voltage, current, and/or combined power received from the mobile device. The power providing connector is disposed at the second end of the body and in one exemplary embodiment, is a threaded connector, and is configured to receive the converted power from the conversion circuit and supply the converted power to the connector of an electronic cigarette.

These figures and embodiments herein are meant to illustrate and further describe the present disclosure, however these are not intended to limit any aspect of the device.

### BRIEF DESCRIPTION OF THE DRAWINGS

Some embodiments of this present disclosure may be further understood by the detailed descriptions and corresponding figures.

FIG. 1 is a diagram of a device for powering an electronic cigarette according to an example embodiment of the present disclosure;

FIG. 2 is a diagram that illustrates the device and the connections with the mobile phone and electronic cigarette according to an example embodiment of the present disclosure; and

FIG. 3 depicts views of an assembled device for powering an electronic cigarette and an exploded view of the same device according to an example embodiment of the present disclosure.

FIG. 4 illustrates another device for powering an electronic cigarette according to an example embodiment of the present disclosure;

FIG. 5 depicts an electronic cigarette cartridge for use with example embodiments of the present disclosure;

FIG. 6 is an exploded view of a device for powering an electronic cigarette according to an example embodiment of the present disclosure;

FIG. 7 illustrates a side view of the device for powering an electronic cigarette according to the example embodiment of FIG. 4;

FIG. 8 illustrates another device for powering an electronic cigarette according to an example embodiment of the present disclosure; and

FIG. 9 illustrates still another device for powering an electronic cigarette according to an example embodiment of the present disclosure including a foldable connector.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. Although various embodiments are being described in the context of using the device with a mobile phone, the device may be used with other types of portable devices, mobile communication terminals, or self-contained power units or batteries. These portable devices can include, but are not limited to, tablet computers, mobile phones, laptop computers, portable solar power generation units, portable mechanical power generation units, and other portable electronic devices. Further, it is appreciated that while the term “electronic cigarette” is used herein to describe the apparatus that can be powered by a mobile phone or portable device, the term “electronic cigarette” is used to encompass e-cigs, vape pens, or other vaping devices that use a similar mechanism of using a small heating element to heat and vaporize or atomize liquid from a reservoir for inhalation by a user.

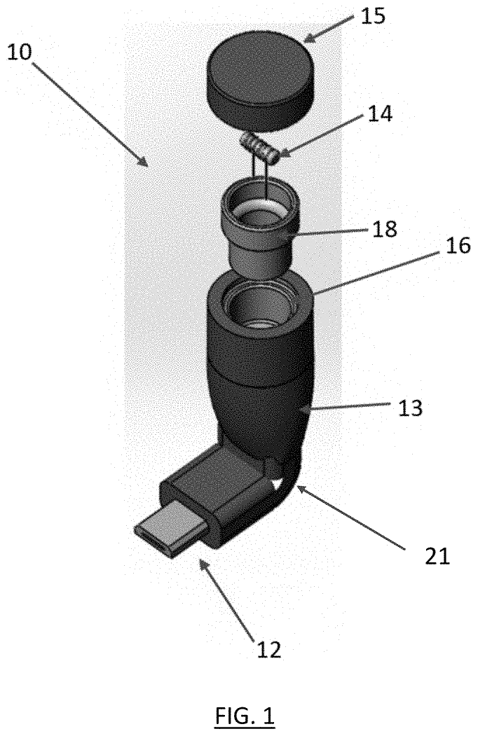

FIG. 1 is a diagram of a device 10 configured to convert and transmit power from a mobile phone to an electronic cigarette. The device 10 includes a body 13, power receiving connector 12, a conversion circuit housed within a cavity defined by the body, a threaded connector 16, a ceramic seat 18, a heating wire 14, and a cap 15. The power receiving connector 12 may be a mobile phone dock connections, including but not limited to, an Apple® lighting dock connector, USB (Universal Serial Bus) connector (e.g., USB type-A, USB type-B, USB type-B SuperSpeed, USB type-C, USB mini/micro), or other proprietary or industry standard connector found in mobile phones and portable devices. The conversion circuit housed within the body may be configured to receive power from the mobile phone or portable device through the power receiving connector 12. The conversion circuit may be configured to convert the power received from the mobile phone or portable device to a power (voltage and current) compatible with the power draw of an electronic cigarette. The power draw may be determined based on the type of electronic cigarette to be coupled to the device 10 or may be variable.

Optionally the conversion circuit may be configured to charge an energy storage device, such as a capacitor circuit or small rechargeable battery, to a minimal level of power necessary for the electronic cigarette 28 to be used. Once the conversion circuit charges up the energy storage device, the conversion circuit discharges the power to the threaded connector 16 for use by the electronic cigarette 28. Such a configuration may be useful in an example embodiment in which the steady-state power from the mobile phone or portable device is insufficient to heat the heating wire 14 or provide enough power for the electronic cigarette, and power is drawn by the electronic cigarette in high-draw periods between periods of low or no draw in which the energy storage device may be charged.

According to an example embodiment, the power providing connector is a threaded connector 16 may be configured to releasably connect to the electronic cigarette 28 to conduct power to a power circuit of the electronic cigarette 28. In such an embodiment, the electronic cigarette may contain the heating wire 14 within the body of the electronic cigarette, such that it is not part of the device 10. Thus, the conversion circuit may connect to the threaded connector 16, which in turn connects to the electronic cigarette in a manner to electronically communicate the power from the conversion circuit to the electronic cigarette. Optionally, the power providing connector 16 can take the form of another type of male-female connection, where one end of an electronic cigarette can be inserted into the connector so as to allow for power to be provided to the battery of the electronic cigarette.

The cap 15 may be releasably connected over an end of the threaded connector 16 for protection of the device 10 so material such as dirt and liquids do not cause a hindrance to the device's functionality. The cap may be tethered (not shown) to the device 10 to prevent loss.

According to the example embodiment of FIG. 1, the body 13 may include a hinge 21 disposed between the power receiving connector 12 of the device 10 and the power providing connector 16. In the present exemplary embodiment, the power providing connector 16 is a threaded connector. Such a configuration may provide flexibility in the use of an electronic cigarette that is received within the threaded connector 16 while the connector 12 is received within a port of a mobile device. The hinge, while illustrated as configurable through a range of about 180 degrees could be a hinge providing two degrees of freedom, enabling pivoting of an electronic cigarette received within the threaded connector 16 through two or more different axes. Optionally, the hinge could be a ball-and-socket arrangement allowing still further freedom of rotation between an electronic cigarette and a mobile device connected to the device 10. As will be appreciated by one of ordinary skill in the art, regardless of the type of hinge or joint used between the connector 12 and the power providing connector 16, electrical connection from the connector 12 to the conversion circuit will be maintained through either flexible wiring or through contacts that enable pivoting motion, for example.

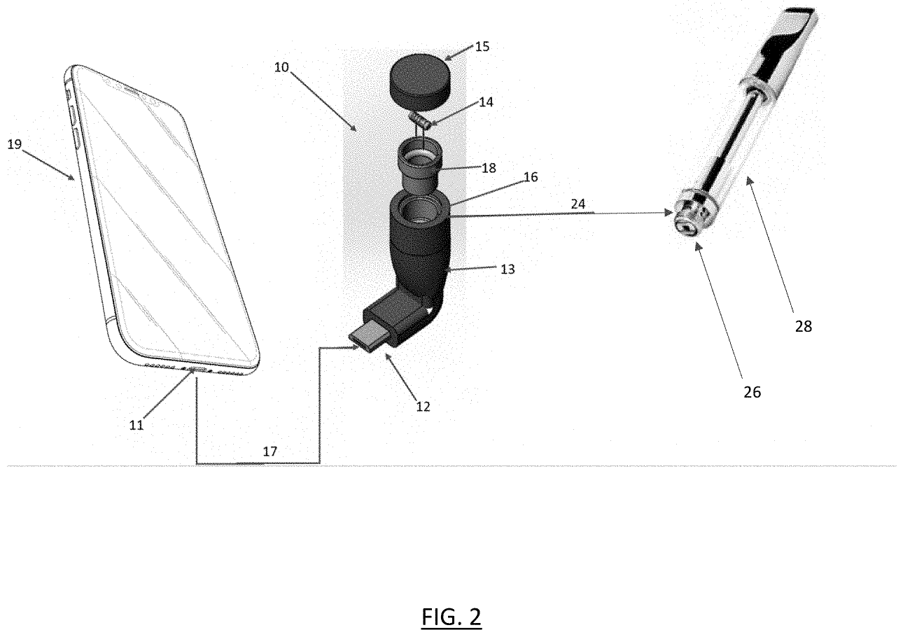

FIG. 2 is a diagram that illustrates how the device 10 can be connected to a power output interface of the mobile phone 19 and to a power input interface of the electronic cigarette 28. The mobile phone 19 can be any type of mobile phone or portable device with a connector port 11 capable of outputting power. The mobile phone 19 may output power through the connector port 11. The power receiving connector 12 of the device 10 may be inserted into the connector port 11 as shown by the dock connection arrow 17. While the power receiving connector 12 is connected to the connector port 11, the mobile phone 19 can output power to the device 10. The device 10 receives the power, which may be converted by the conversion circuit to convert the voltage, current, and/or combined power according to the power needed by the electronic cigarette and then the conversion circuit supplies the converted power through the threaded connector 16 to the electronic cigarette 28 as described above.

According to some embodiments, the power output of the mobile phone or portable device through the connector port 11 may be based on the conversion circuit configuration, where the mobile phone or portable device supplies power as needed within the limits of the circuitry of the mobile phone or portable device 19. Optionally, device 10 may be configured to operate in cooperation with a mobile device app, which may be a software program installed on the mobile phone 19. This mobile device app may enable a user to configure a power output of the connector port 11 to allow a user to “dial-in” a specific voltage that the user desires to be supplied to device 10 and, in turn, the electronic cigarette 28. Using voltage control within a mobile device app interface may alter the user experience of the electronic cigarette by controlling the amount of vapor created during inhalation by a user. Further, the mobile device app interface may provide or measure user metrics, such as total time of use of the electronic cigarette, a power consumption metric which may be indicative of an amount of vapor generated/consumed by a user, etc. These features may enhance the user experience of the device 10. According to some embodiments, the mobile device app may be configured to be initiated by the mobile phone 19 upon insertion of the power receiving connector 12 into the connector port 11 to provide a seamless interface to the user. The mobile device app may optionally be stored on a memory within the device 10 and loaded to the mobile device or mobile phone 19 in response to the power receiving connector being inserted into the connector port 11.

Referring back to the structure of the device 10, the power providing connector 16 may be any of a plurality of different power providing connectors common to electronic cigarettes, including threaded connectors, such as a 510 female connector or 808 male connector. As noted above, the power providing connector 16 may receive power from the conversion circuit, and the conversion circuit may supply power to the electronic cigarette 28. The threaded power providing connector 16 may be connected to the electronic cigarette 28 in such a way as indicated by the threaded connection arrow 24. The threaded connection arrow 24 illustrates where the threaded power providing connector 16 on the device 10 is connected to the electronic cigarette threaded connector 26. The electronic cigarette threaded connector 26 may be any power interface such as but not limited to a 510 male connector or an 808 female connector.

Electronic cigarette batteries generally operate using a voltage in a range between about three volts to about five volts and a capacity in a range between about 200 mAh to about 400 mAh. The mobile phone 19 may not necessarily provide enough voltage, current, and/or power needed to operate the electronic cigarette 28. So the conversion circuit may be configured to amplify the voltage, current, and/or the combined power from a level that is output by the mobile phone 19 to another level that is sufficient to operate the electronic cigarette 28. Further, as noted above, steady state power from the mobile phone 19 may be stored in a capacitor or the like to provide a higher level of power in shorter, periodic outputs to the electronic cigarette 28 as necessary for operation.

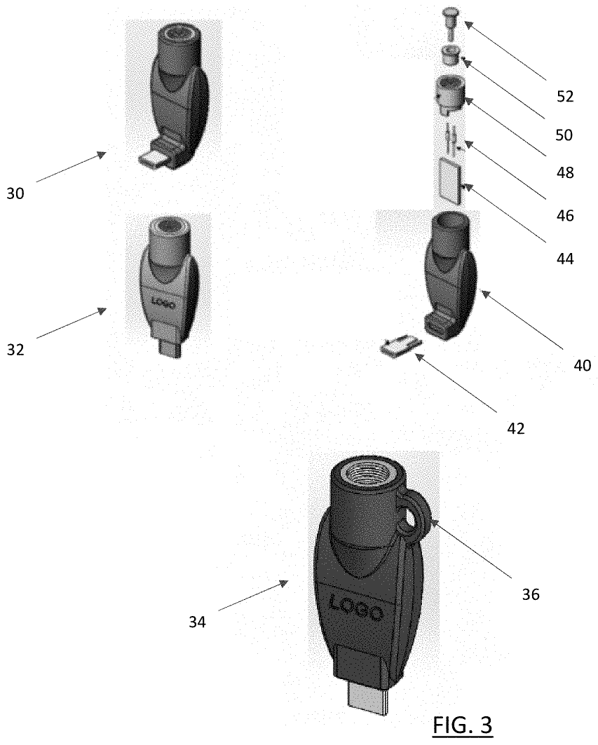

FIG. 3 illustrates additional example embodiments of a device for powering electronic cigarettes from a mobile device. As shown, embodiments may include a form factor that is hinged 30 or potentially fixed in the right-angle position shown, or a straight, unhinged embodiment 32. The body of example devices may further be configured with convenience features such as the keyring loop 36 of device 34. Further illustrated in FIG. 3 is an exploded view of a configuration of the device of example embodiments. As shown, the device includes a body 40 which houses the components of the device, and from which extends a connector 42 configured to be received by a mobile device such as a mobile phone. Optionally, the connector 42 may be a USB-type (Universal Serial Bus) connector or a proprietary connector such as the Apple® lightning connector. The connector 42 may be in electronic communication with a miniature printed circuit board (PCB) 44, which may in turn be connected via wires 46, which may include resistors as appropriate for the heating element configuration, to an electrode 52. The electrode 52 may be seated within an insulating sleeve 50, such as a silicone insulation sleeve or a ceramic insulation sleeve. The electrode 52 and insulating sleeve 50 may be received within a threaded connector 48, which may be a 510 threaded female port which is a typical standard for electronic cigarette devices. The threaded connector 48 may function as a negative electrode while the electrode 52 may function as a positive electrode, thereby providing power from the mobile device attached to connector 42 across the positive 52 and negative 48 electrodes to a connected electronic cigarette.

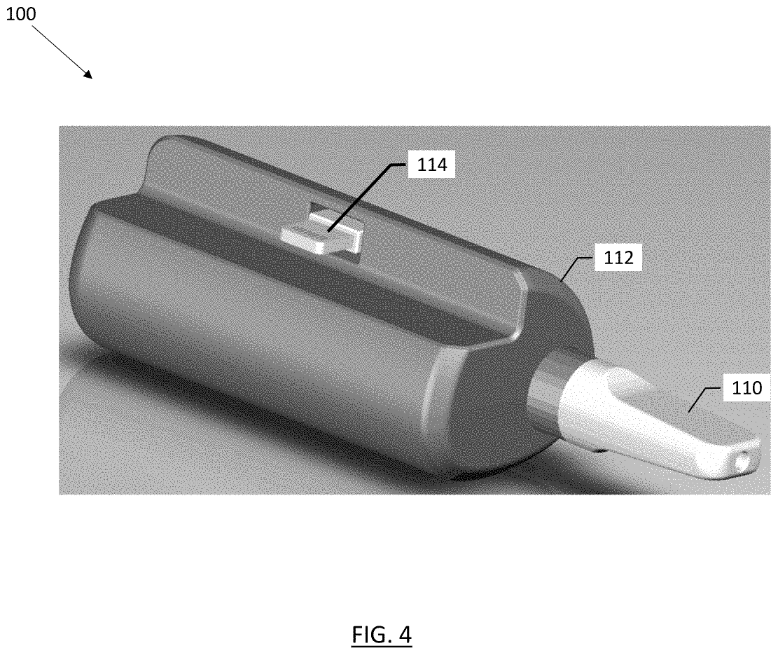

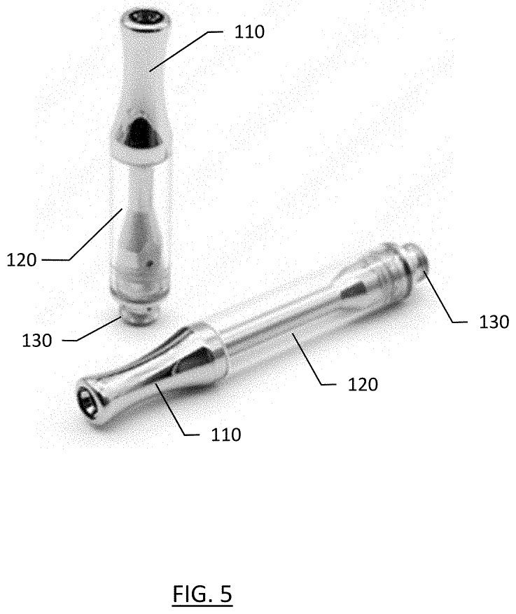

FIG. 4 illustrates another example embodiment of a device 100 configured to convert and transmit power from a mobile device such as a mobile phone to an electronic cigarette. As shown, the form factor of the device 100 of FIG. 4, the device includes a mouth piece 110, a device body 112, and a connector 114. The mouth piece may be removable and interchangeable, and may incorporate the electronic cigarette fluid chamber cartridge. FIG. 5 illustrates an example embodiment of the mouth piece 110 and cartridge 120 removed from the device body 112. The mouth piece 110 and cartridge 120 may include a threaded end connector 130 by which the cartridge is connected to the device body 112, similar to that shown in the embodiment of FIGS. 2 and 3.

Referring back to FIG. 4, the cartridge 120 may be received within the device body 112 and secured to the device body via the threaded connector 130, which may engage mating threads of a connector within the device body. The device body 112 may house a printed circuit board, electrode, and insulating sleeve as illustrated with respect to FIG. 3, or any similar configuration which may enable the functionality of the device 100 as an electronic cigarette.

Within the body the printed circuit board may be used in concert with a power storage device, which may include batteries or super capacitors. As the power available from a device such as a mobile phone may not be of sufficient current or have sufficient instantaneous power to heat the heating element of an electronic cigarette cartridge, the device 100 may include temporary power storage devices to be charged using the mobile device and able to be rapidly discharged to power the electronic cigarette. In this manner, super capacitors may be well suited to receive power from the mobile device, and to provide, in turn, power to the heating element of the electronic cigarette through rapid discharge. The super capacitors may be sized based on the electronic cigarette duty cycle, and different versions of the device 100 may be available with different sizes of super capacitors to enable higher duty cycles as needed.

Power may be received by the super capacitors at a rate lower than that with which they are discharged, though this lower rate may not be perceptible by a user as the rate of charge of the super capacitors may be such that the duty cycle of use of the electronic cigarette may not exceed the charging rate of the super capacitors. Power may be expelled to the cartridge and heating element thereof through a metal plate that makes contact with the cartridge when the cartridge is threadedly engaged within the device body 112 via threaded connector 130. The contact with the metal plate within the device body 112 may be made via the threaded connector 130, which may be a 510-thread connector, a conventional threaded gage for electronic cigarettes. The threaded connector within the device body 112 may use a 510-thread connector to serve as a universal power source for electronic cigarettes.

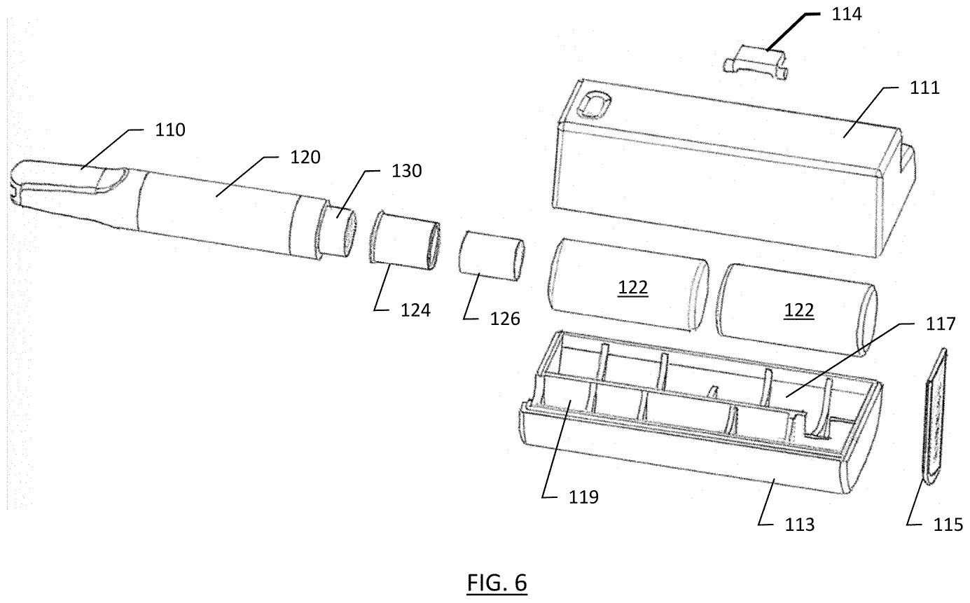

FIG. 6 illustrates an exploded view of the electronic cigarette device including the device body 112 split into halves 111 and 113. Within the body are two supercapacitors 122 that are charged via connector 114, connected through printed circuit board (PCB) 115. The super capacitors 122 may be received within the device body in cavity 117, while the electronic cigarette cartridge 120 may be received within cavity 119 of the device body. The threaded connector 130 of the electronic cigarette cartridge 120 may be received within threaded collar 124 to engage element 126, which is connected via the PCB 115 to the super capacitors 122, and configured to receive power discharged from the super capacitors to impart functionality to the electronic cigarette cartridge upon demand by a user via inhalation.

According to some example embodiments described herein, the super capacitors may require some time to charge from the power of the mobile device, and the electronic cigarette power device may not be constantly ready to support powering the electronic cigarette cartridge. In such an example embodiment, an indication may be provided to a user when the super capacitors are charged and the electronic cigarette is ready for use. The indicator may be an LED light, for example. In such an embodiment, the LED may be illuminated red or not illuminated when the super capacitors are not ready to provide sufficient power to the electronic cigarette. When the super capacitors have sufficient charge, the LED indicator may be illuminated green, indicating to a user that they may inhale from the electronic cigarette. Such an indicator may be useful when the super capacitors take more than a second or two to charge between uses, or for when power from a mobile device is provided slowly.

Power may be received by the device 100 via connector 114. This connector 114 may be an Apple® lightning type connector for use with Apple® devices such as iPhones® or even iPads®. While the connector 114 is illustrated as a lightning connector, the connector may be a USB type connector, such as a micro-USB, mini-USB, USB-C, etc., or any connector that may be used by devices suitable for powering the device 100 of example embodiments described herein. Further, as mobile devices may now receive and provide power via wireless charging, embodiments may include wireless charging functionality where power to the device 100 is received via an inductive coil embedded within the device 100 such that no connector is necessary in such embodiments. Wireless charging may be used to provide a charge to the super capacitors described above in a manner similar to that of power received through connector 114 to enable functionality of the electronic cigarette.

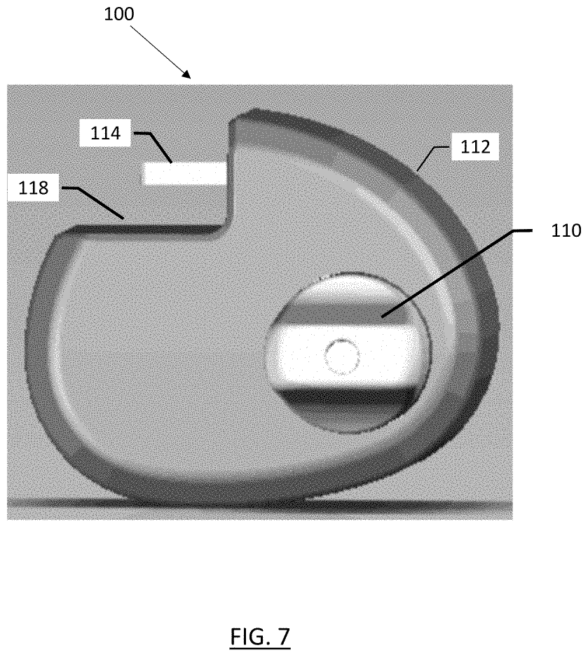

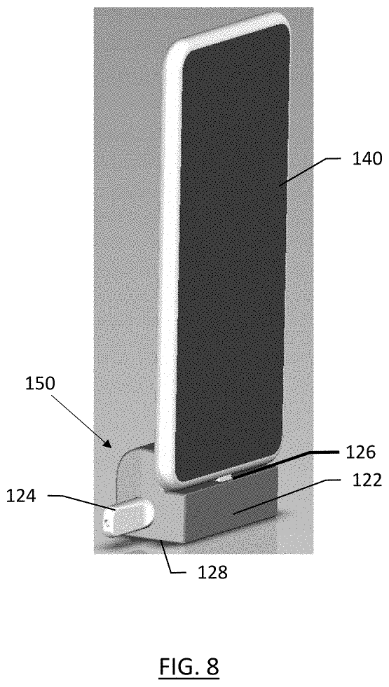

FIG. 7 illustrates an end-view of the device 100 of FIG. 4, including the device body 112, the mouth piece 110, and the connector 114. As shown, the embodiment of FIG. 7 includes a rounded body shape having a notch 118 to receive the mobile device when connected to connector 114. However, example embodiments described herein may include additional functionality, such as functioning as a phone stand. FIG. 8 illustrates such an example embodiment including a mobile device 140 attached to an electronic cigarette device 150 including a device body 122, mouth piece 124, and connector 126 interfacing with the mobile device 140. According to the embodiment of FIG. 8, the device body 122 includes a flat edge 128 opposite the connector 126 to enable a mobile device 140 to be held in a vertical or near vertical position as shown.

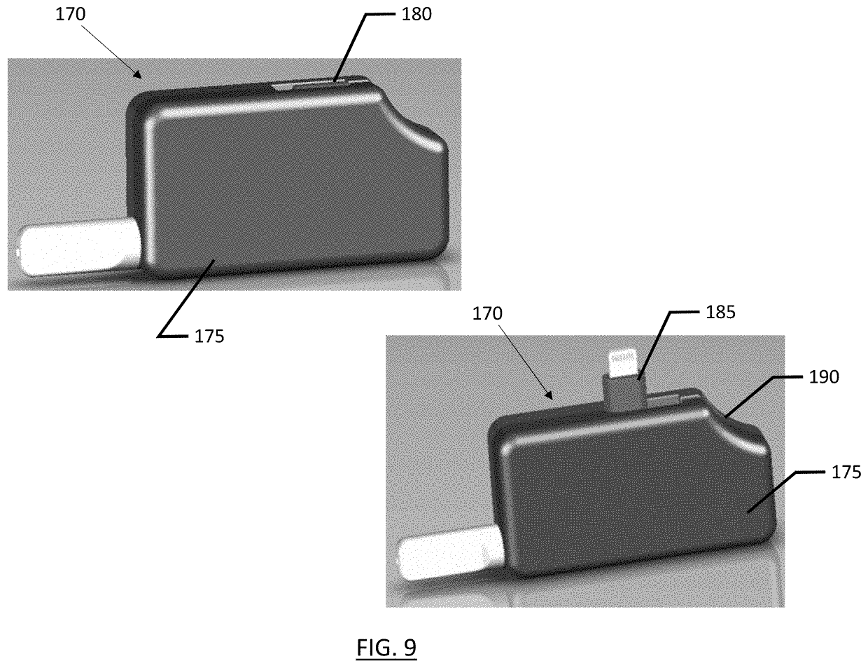

FIG. 9 illustrates still another example embodiment of the electronic cigarette device as described herein. As shown, the device 170 may include a device body 175; however, the connector 185 may be foldably received within a cavity 180 of the device body 175. In this manner, the connector 185 may be folded when the device 170 is not in use and connected to a mobile device, and may be deployed at 185 when it is to be connected to a mobile device. According to such an embodiment, a recess 190 may be included whereby the connector 185 may extend into the recess sufficiently to enable a user to engage the end of the connector with a finger to pivot the connector to the position shown by connector 185.

According to some embodiments, the device may include multiple connectors for use with different types of mobile devices. For example, using the embodiment of FIG. 9, the device body 175 may include two connectors that can be folded into the body, into cavity 180. The user may deploy whichever connector is appropriate for the mobile device they will use to power the electronic cigarette device 170. The connectors may each be electronically connected to the printed circuit board within the device body 175, where power may be received from either connector to provide the functionality described above.

In summary, embodiments of the present disclosure describe a device for powering an electronic cigarette from a mobile phone. The power from the mobile phone may be supplied from the connector port to the mobile phone dock connector. The mobile phone dock connector may supply the power to the conversion circuit that is configured to amplify or convert the voltage, current, and/or power as necessary for operation of the electronic cigarette. The conversion circuit may supply the converted power to the power providing connector of the device, which in turn is configured to supply the converted power to the connector of the electronic cigarette.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A device for powering an electronic cigarette comprising:
a body;
a power receiving connector extending from the body and configured to be received within a power port of a mobile device;
a temporary power storage device within the body and configured to receive power from a mobile device connected to the power receiving connector;
a threaded connector within the body configured to engage an electronic cigarette cartridge, wherein the temporary power storage device within the body is configured to provide power via the threaded connector to the electronic cigarette cartridge.

2. The device of claim 1, wherein the power receiving connector is pivotably attached to the body, wherein the power receiving connector defines a first, stowed position when folded into a cavity of the body, wherein the power receiving connector defines a second, deployed position when unfolded and positioned to engage a mobile device.

3. The device of claim 1, further comprising a printed circuit board within the body, wherein the power receiving connector and the temporary power storage device are electronically connected to the printed circuit board, wherein the printed circuit board regulates power flow from the power receiving connector to the temporary power storage device.

4. The device of claim 3, wherein the printed circuit board further controls power discharged from the temporary power storage device to the threaded connector within the body.

5. The device of claim 1, wherein the temporary power storage device comprises one or more super capacitors.

6. The device of claim 1, wherein the power receiving connector extends from a first side of the body, wherein the body defines a substantially flat surface on a side of the body opposite of the power receiving connector.

7. The device of claim 6, wherein the device is configured to support a mobile device in an upright position in response to the power port of the mobile device engaging the power receiving connector, and the device being positioned to rest on its substantially flat surface.

8. The device of claim 1, wherein in response to an electronic cigarette cartridge engaging the threaded connector within the body, a mouth piece of the electronic cigarette cartridge extends outside of the body.

9. The device of claim 8, wherein in response to an electronic cigarette cartridge engaging the threaded connector within the body, the fluid reservoir of the electronic cigarette cartridge is fully received within the body.

10. A device for supporting a mobile device in an upright position comprising:
a body;
a power receiving connector extending from the body and configured to be received within a power port of a mobile device, wherein the body defines a substantially flat surface opposite a side from which the power receiving connector extends;
a threaded connector within the body configured to engage an electronic cigarette cartridge, wherein the threaded connector is configured to receive power from the power receiving connector to power via the threaded connector to an electronic cigarette cartridge.
The device of claim 1, wherein the power receiving connector is pivotably attached to the body, wherein the power receiving connector defines a first, stowed position when folded into a cavity of the body, wherein the power receiving connector defines a second, deployed position when unfolded and positioned to engage a mobile device.

11. The device of claim 10, further comprising a temporary power storage device within the body and configured to receive power from a mobile device connected to the power receiving connector.

12. The device of claim 11, further comprising a printed circuit board within the body, wherein the power receiving connector and the temporary power storage device are electronically connected to the printed circuit board, wherein the printed circuit board regulates power flow from the power receiving connector to the temporary power storage device.

13. The device of claim 12, wherein the printed circuit board further controls power discharged from the temporary power storage device to the threaded connector within the body.

14. The device of claim 11, wherein the temporary power storage device comprises one or more super capacitors.

15. The device of claim 10, wherein in response to an electronic cigarette cartridge engaging the threaded connector within the body, a mouth piece of the electronic cigarette cartridge extends outside of the body.

16. The device of claim 15, wherein in response to an electronic cigarette cartridge engaging the threaded connector within the body, the fluid reservoir of the electronic cigarette cartridge is fully received within the body.

17. A device for powering an electronic cigarette, comprising:
a body defining a first end and a second end;
a power receiving connector extending from the first end and configured to be received within a power output port of a mobile device;
a power providing connector disposed at the second end of the body;
a circuit disposed within the body and electronically coupled between the power receiving connector and the power providing connector, wherein the conversion circuit is configured to convert or pass through the voltage, current, and/or combined power received from the mobile device and output the converted voltage, current, and/or combined power to the power providing connector.

18. The device of claim 17, wherein the conversion circuit is configured to convert the voltage, current, and/or the combined power from a first level that is received from the mobile device to a second level, different from the first level, sufficient to operate the electronic cigarette.

19. The device of claim 17, wherein the conversion circuit further comprises an energy storage device, wherein the power received from the mobile device charges the energy storage device to a first level of power, necessary for the electronic cigarette to operate, and wherein the conversion circuit is configured to discharge the power via the power providing connector in response to power demand from the electronic cigarette.

20. The device of claim 19, wherein the energy storage device may include a capacitor circuit or rechargeable battery.
